(19) United States
(12) Patent Application Publication
(10) Pub. No.: US 2015/0306965 A1
(43) Pub. Date: Oct. 29, 2015

(54) Hand-powered jump starter for a vehicle

(71) Applicant: Munther Bader, Norfolk, VA (US)

(72) Inventor: Munther Bader, Norfolk, VA (US)

(21) Appl. No.: 14/694,972

(22) Filed: Apr. 23, 2015

Related U.S. Application Data
(60) Provisional application No. 61/983,490, filed on Apr. 24, 2014.

(51) Int. Cl. B60L 11/18; H02J 7/00

(52) U.S. Cl. CPC B60L 11/1816; H02J 7/0054

(57) ABSTRACT

A hand-powered jump starter for a vehicle is a manually actuated generator, either directly or by storing charge in a capacitor, produces 12V DC at high current for a brief duration sufficient for the vehicle's electric starter motor to turn the engine over.

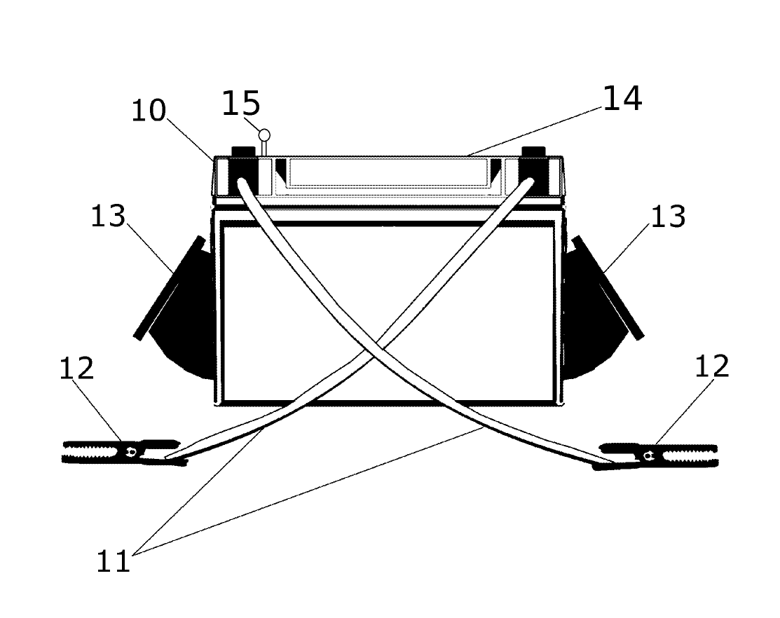

### CROSS-REFERENCE TO RELATED APPLICATIONS

This application claims the benefit of U.S. Provisional Application No. 61/983,490, filed Apr. 24, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to vehicle maintenance tools and accessories, and in particular to a hand-powered jump starter for a vehicle. Few drivers have avoided the unpleasant experience of being stranded with a dead battery, unable to start the vehicle. The cellular telephone has made roadside service available in such situations, and jumper cables may enable the driver to obtain a jump start from an operational vehicle, if one is available and the other driver is willing. But the driver and vehicle may have experienced this problem in the middle of nowhere, or in the middle of the night. Waiting an hour or more for a tow truck to arrive, and paying the high service fee, may not be an attractive option. A hand-powered jump starter for a vehicle, which provides a 12V DC at high current for a brief duration sufficient for the vehicle's electric starter motor to turn the engine over, would resolve this problem.

### SUMMARY OF THE INVENTION

Accordingly, the invention is directed to a hand-powered jump starter for a vehicle. A manually actuated generator, either directly or by storing charge in a capacitor, produces high DC voltage for a brief duration sufficient for the vehicle's electric starter motor to turn the engine over.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and are incorporated into and constitute a part of the specification. They illustrate four embodiments of the invention and, together with the description, serve to explain the principles of the invention.

The FIGURE is a front view of the first exemplary embodiment, displaying the jump starter 10, the cables 11, the clamps 12, the pump levers 13, the handle 14, and the light 15.

### DETAILED DESCRIPTION OF THE INVENTION

Referring now to the invention in more detail, the invention is directed to a hand-powered jump starter 10 for a vehicle. A manually actuated generator, either directly or by storing charge in a capacitor, produces 12V DC at high current for a brief duration sufficient for the vehicle's electric starter motor to turn the engine over.

The first exemplary embodiment provides a jump starter 10, which may be carried in the trunk, glove compartment, or other storage area of a vehicle. The jump starter 10 provides an internal generator, and may also provide an internal capacitor. The jump starter 10 also provides a pair of color-coded cables 11 affixed to the top of the jump starter 11 and terminating in clamps 12, such that they may be affixed to the posts of the battery of a vehicle. A handle 14 is provided on the top surface of the jump starter 10 for carrying. The cable 11 which is intended for connection to the battery's positive post is preferably colored red, and the cable 11 which is intended for connection to the battery's negative post is preferably colored black. The jump starter 10 may also have two buttons, one for a light 15 that may be affixed on the same side of the wires coming from the jump starter 10 in case it will be used at night, and another one to use the internal battery to help users from spending less time and effort jumping a dead battery.

Affixed on each side surface of the jump starter 10, a pump lever 13 is provided. The pump levers 13 turn the generator, which either directly delivers a high-current 12V DC charge via the cables 11 to the battery, or accumulates the charge in a capacitor for delivery to the battery. Either way, the pump levers 13 are understood as being configured for delivering a current to the cables 11. The battery then supplies the charge to the electric starter motor of the vehicle. Alternate embodiments, featuring removable hand cranks or other mechanisms for turning the generator by hand, are also contemplated. The pump levers 13 may be further understood as being configured for powering the light 15, simultaneously with jump starting, if necessary.

To use the first exemplary embodiment, the user connects the red cable 11 to the positive post of the battery, and the black cable 11 to the negative post of the battery. The user then repeatedly depresses the pump levers 13, charging up the capacitor. When a sufficient high-voltage DC charge has been accumulated, the capacitor delivers the charge to the battery, enabling the user to start the vehicle.

The jump starter 10, the pump handles 13, and the handle 14 are preferably manufactured from a rigid, durable material which is water resistant, such as high-impact plastic. The cables 11 are preferably manufactured from braided copper alloy cable sheathed in plastic. The clamps 12 are preferably manufactured from a rigid, durable material which conducts electricity, such as copper alloy, with handles which are preferably manufactured from a rigid, durable material with insulating properties, such as plastic. The generator and the capacitor are preferably manufactured from rigid, durable materials which conduct electricity, such as steel and copper alloy. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A hand powered jump starter for a vehicle comprising a jump starter; a pair of levers; said pair of levers being affixed to each side surface of said jump starter; a pair of cables; said pair of cables being affixed to the top of said jump starter; said pair of cables terminating in a pair of clamps; said pair of levers being configured for applying twelve volts direct current across said pair of clamps.

2. The hand powered jump starter of claim 1 wherein said pair of levers are further configured for powering a light.

3. The hand powered jump starter of claim 1 further comprising a handle; said handle being affixed to the top of said jump starter.

4. The hand powered jump starter of claim 2 further comprising a handle; said handle being affixed to the top of said jump starter.

5. The hand powered jump starter of claim 1 wherein said pair of clamps is configured for attachment to vehicle batter posts.

6. The hand powered jump starter of claim 2 wherein said pair of clamps is configured for attachment to vehicle batter posts.

7. The hand powered jump starter of claim 3 wherein said pair of clamps is configured for attachment to vehicle batter posts.

8. The hand powered jump starter of claim 4 wherein said pair of clamps is configured for attachment to vehicle batter posts.
